(19) United States
(12) Patent Application Publication
(10) Pub. No.: US 2010/0282870 A1
(43) Pub. Date: Nov. 11, 2010

(54) Spraying Gun Whose Grip is Positioned Closely

(76) Inventor: Chin-Yuan Chen, Lu Kang Town (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/436,927

(22) Filed: May 7, 2009

(51) Int. Cl. B05B 9/00

(52) U.S. Cl. 239/525

(57) ABSTRACT

A spraying gun includes a handle having a mounting portion which has a receiving hole, a shank connected with the handle and having an end provided with a plug inserted into the receiving hole, a locking cap mounted on the shank and locked onto the mounting portion, an extension secured on the locking cap, and a resilient grip mounted on the shank and locked onto the extension. The extension has an outer wall provided with a plurality of positioning bosses engaging the grip. The grip has an end portion surrounding the extension and engaging the positioning bosses. Thus, the end portion of the grip engages the positioning bosses so that the grip is locked onto the extension closely and tightly to prevent the grip from being detached from the extension during a long-term utilization.

### BACKGROUND OF THE INVENTION

1. Field of the Invention

The present invention relates to a spraying gun and, more particularly, to a spraying gun for watering plants or washing cars.

2. Description of the Related Art

A conventional spraying gun in accordance with the prior art shown in FIG. 5 comprises a handle 60 having a threaded mounting portion 61, a shank 50 connected with the handle 60 and having an end provided with a plug 51 inserted into the mounting portion 61 of the handle 60, a threaded locking cap 53 mounted on the shank 50 and threadedly locked onto the mounting portion 61 of the handle 60 to attach the shank 50 to the handle 60, a grip 54 mounted on the shank 50 and abutting the locking cap 53, and a limit ring 55 secured on the shank 50 and abutting an inner wall of the locking cap 53 to limit the locking cap 53 on the shank 50. The mounting portion 61 of the handle 60 has an inner wall provided with a limit rib 62. The plug 51 of the shank 50 has a periphery provided with a limit slot 52 mounted on the limit rib 62 of the mounting portion 61 when the plug 51 of the shank 50 is inserted into the mounting portion 61 of the handle 60. The grip 54 is fixed on the shank 50 by an adhesive. However, the adhesive located between the grip 54 and the shank 50 is easily worn out or torn during a long-term utilization so that the grip 54 is easily detached from the shank 50. In addition, it is necessary to bond the adhesive between the grip 54 and the shank 50 and to dry the adhesive slowly, thereby complicating the procedures of fabrication and increasing the costs of fabrication.

### BRIEF SUMMARY OF THE INVENTION

In accordance with the present invention, there is provided a spraying gun, comprising a handle having a mounting portion which has an inside provided with a receiving hole, a shank connected with the handle and having an end provided with a plug inserted into the receiving hole of the mounting portion, a locking cap mounted on the shank and locked onto the mounting portion of the handle to attach the shank to the handle, an extension secured on the locking cap, and a resilient grip mounted on the shank and locked onto the extension. The extension has an outer wall provided with a plurality of positioning bosses engaging the grip to position the grip on the extension. The grip has an end portion surrounding the extension and engaging the positioning bosses of the extension.

The primary objective of the present invention is to provide a spraying gun whose grip is positioned closely and exactly.

Another objective of the present invention is to provide a spraying gun, wherein the end portion of the grip closely engages the positioning bosses of the extension so that the grip is locked onto the extension closely and tightly so as to prevent the grip from being detached from the extension during a long-term utilization.

A further objective of the present invention is to provide a spraying gun, wherein the grip is directly mounted on and combined with the extension by the positioning bosses of the extension without needing aid of an adhesive, thereby simplifying the procedures of fabrication and decreasing the costs of fabrication.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a spraying gun in accordance with the preferred embodiment of the present invention.

FIG. 2 is an exploded perspective view of the spraying gun as shown in FIG. 1.

FIG. 3 is a front cross-sectional view of the spraying gun as shown in FIG. 1.

FIG. 4 is a schematic operational view of the spraying gun as shown in FIG. 3.

FIG. 5 is a front cross-sectional view of a conventional spraying gun in accordance with the prior art.

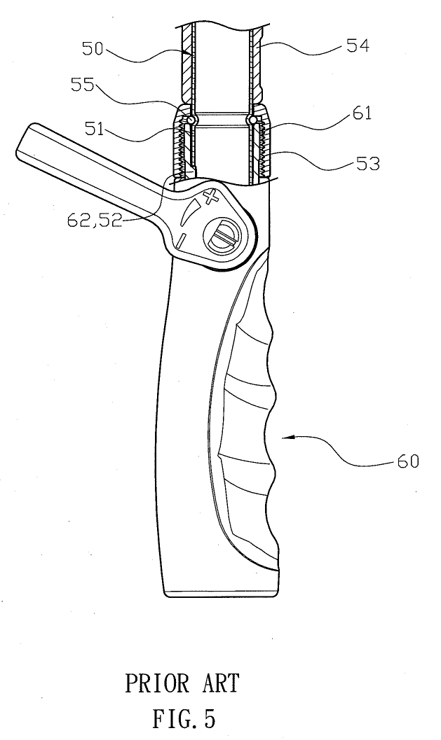

### DETAILED DESCRIPTION OF THE INVENTION

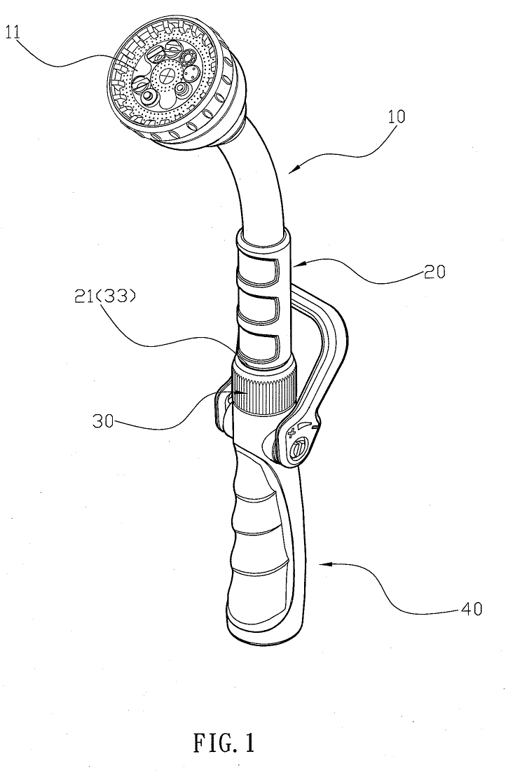

Referring to the drawings and initially to FIGS. 1-3, a spraying gun in accordance with the preferred embodiment of the present invention comprises a handle 40 having a mounting portion 41 which has an inside provided with a receiving hole 42, a shank 10 connected with the handle 40 and having a first end provided with a plug 12 inserted into the receiving hole 42 of the mounting portion 41, a locking cap 30 mounted on the shank 10 and locked onto the mounting portion 41 of the handle 40 to attach the shank 10 to the handle 40, an extension 31 secured on the locking cap 30, a resilient grip 20 mounted on the shank 10 and locked onto the extension 31, and a limit ring 14 secured on the shank 10 and abutting an inner wall of the locking cap 30 to limit the locking cap 30 on the shank 10.

The locking cap 30 has an end portion integrally formed with the extension 31. The extension 31 extends from the end portion of the locking cap 30 and extends in an axial direction of the locking cap 30. The extension 31 has a substantially cylindrical cross-sectional profile. The extension 31 has a diameter smaller than that of the locking cap 30 so that a stop shoulder 33 is formed between the locking cap 30 and the extension 31 and abuts the grip 20 to stop movement of the grip 20. The extension 31 has an inner wall provided with a mounting hole 34 mounted on the shank 10 and an outer wall provided with a plurality of positioning bosses 32 engaging the grip 20 to position the grip 20 on the extension 31.

The grip 20 is made of a soft material, such as a rubber, plastic material or a foam material. The grip 20 has an inner wall provided with a plurality of positioning grooves 22 to position the positioning bosses 32 of the extension 31. The grip 20 has an end portion 21 surrounding the extension 31 and engaging the positioning bosses 32 of the extension 31. The end portion 21 of the grip 20 has a diameter smaller than that of the extension 31 so that the end portion 21 of the grip 20 is closely fitted onto the extension 31 by the resilience of the grip 20. The end portion 21 of the grip 20 abuts and is stopped by the stop shoulder 33 between the locking cap 30 and the extension 31.

The receiving hole 42 of the mounting portion 41 has a wall provided with a limit rib 43. The shank 10 a second end provided with a spraying nozzle 11. The plug 12 of the shank 10 has a periphery provided with a limit slot 13 mounted on the limit rib 43 of the mounting portion 41 when the plug 12 of the shank 10 is inserted into the receiving hole 42 of the mounting portion 41.

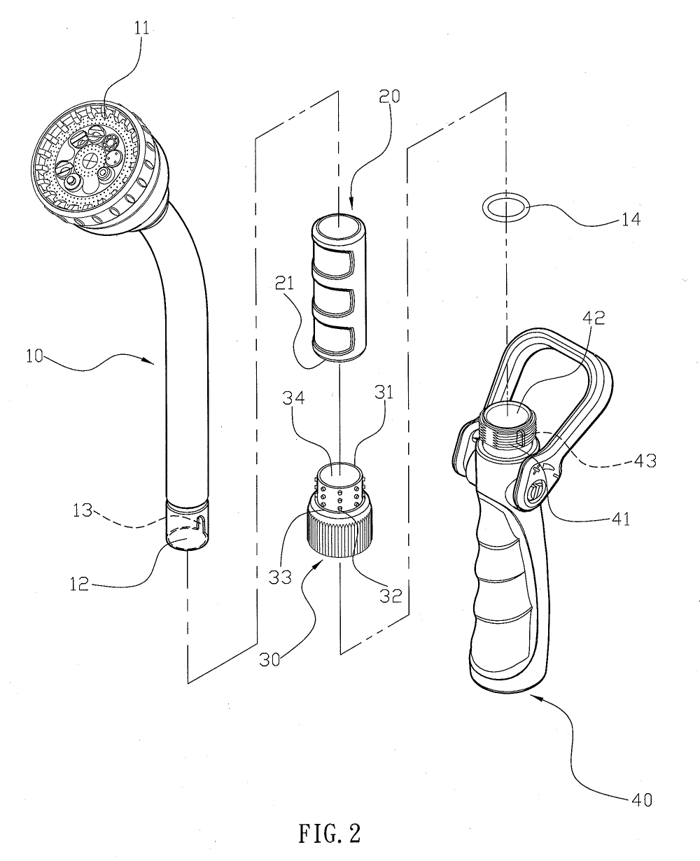

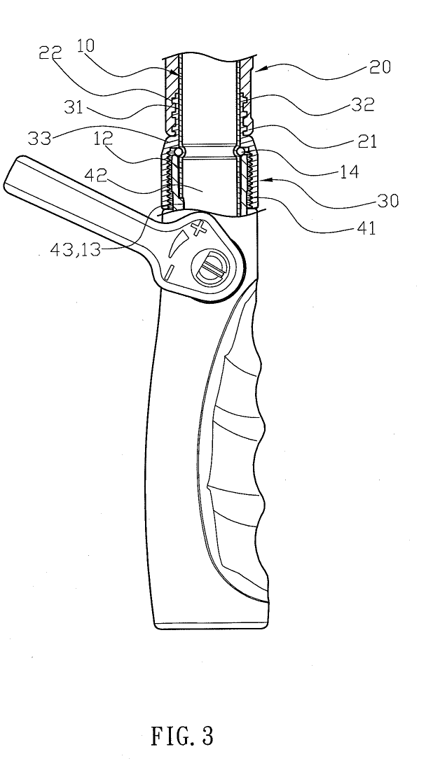

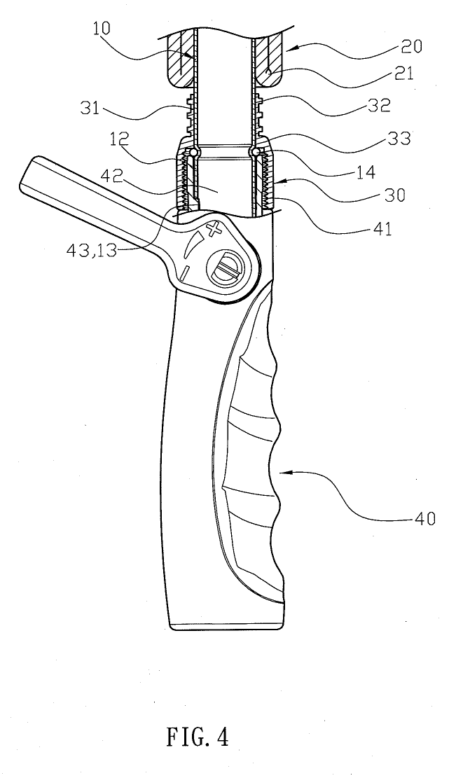

In assembly, referring to FIGS. 3 and 4 with reference to FIGS. 1 and 2, the grip 20 is initially mounted on the shank 10. Then, the locking cap 30 is mounted on the shank 10 and limited by the limit ring 14. At this time, the locking cap 30 is movable axially and rotatable relative to the shank 10. Then, the plug 12 of the shank 10 is inserted into the receiving hole 42 of the mounting portion 41, and the limit slot 13 of the plug 12 is mounted on the limit rib 43 of the mounting portion 41 to prevent the shank 10 from being rotatable relative to the mounting portion 41 of the handle 40. Then, the locking cap 30 is rotated relative to the shank 10 and is screwed onto the mounting portion 41 of the handle 40 to attach the shank 10 to the handle 40. At this time, the grip 20 is spaced from the extension 31 as shown in FIG. 4. Finally, the grip 20 is moved toward the extension 31 so that the grip 20 is mounted on the extension 31, and the end portion 21 of the grip 20 is stopped by the stop shoulder 33 between the locking cap 30 and the extension 31 as shown in FIG. 3. At this time, the end portion 21 of the grip 20 engages the positioning bosses 32 of the extension 31 and is formed with a plurality of positioning grooves 22 by the resilience of the grip 20 to position the positioning bosses 32 of the extension 31 so that the grip 20 is locked onto and combined with the extension 31 closely and tightly to prevent the grip 20 from being detached from the extension 31.

Accordingly, the end portion 21 of the grip 20 closely engages the positioning bosses 32 of the extension 31 so that the grip 20 is locked onto the extension 31 closely and tightly so as to prevent the grip 20 from being detached from the extension 31 during a long-term utilization. In addition, the grip 20 is directly mounted on and combined with the extension 31 by the positioning bosses 32 of the extension 31 without needing aid of an adhesive, thereby simplifying the procedures of fabrication and decreasing the costs of fabrication.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A spraying gun, comprising:
a handle having a mounting portion which has an inside provided with a receiving hole;
a shank connected with the handle and having an end provided with a plug inserted into the receiving hole of the mounting portion;
a locking cap mounted on the shank and locked onto the mounting portion of the handle to attach the shank to the handle;
an extension secured on the locking cap;
a resilient grip mounted on the shank and locked onto the extension.

2. The spraying gun of claim 1, wherein the extension has an outer wall provided with a plurality of positioning bosses engaging the grip to position the grip on the extension.

3. The spraying gun of claim 2, wherein the grip has an inner wall provided with a plurality of positioning grooves to position the positioning bosses of the extension.

4. The spraying gun of claim 2, wherein
the extension has a diameter smaller than that of the locking cap;
a stop shoulder is formed between the locking cap and the extension and abuts the grip to stop movement of the grip.

5. The spraying gun of claim 4, wherein the grip has an end portion surrounding the extension and engaging the positioning bosses of the extension.

6. The spraying gun of claim 5, wherein the end portion of the grip abuts and is stopped by the stop shoulder between the locking cap and the extension.

7. The spraying gun of claim 5, wherein
the end portion of the grip has a diameter smaller than that of the extension;
the end portion of the grip is closely fitted onto the extension by the resilience of the grip.

8. The spraying gun of claim 1, wherein the locking cap has an end portion integrally formed with the extension.

9. The spraying gun of claim 8, wherein
the extension extends from the end portion of the locking cap;
the extension extends in an axial direction of the locking cap.

10. The spraying gun of claim 1, wherein the extension has a substantially cylindrical cross-sectional profile.

11. The spraying gun of claim 1, wherein the extension has an inner wall provided with a mounting hole mounted on the shank.
